(19) United States
(12) Patent Application Publication
(10) Pub. No.: US 2008/0024395 A1
(43) Pub. Date: Jan. 31, 2008

(54) Plasma display apparatus

(76) Inventors: Satoshi Yuri, Yokohama (JP); Hidenori Ohnuki, Kawasaki (JP); Akihiro Machida, Awa (JP)

Correspondence Address: MCDERMOTT WILL & EMERY LLP, 600 13TH STREET, N.W., WASHINGTON, DC, 20005-3096, US

(21) Appl. No.: 11/699,575

(22) Filed: Jan. 30, 2007

(30) Foreign Application Priority Data
Jul. 28, 2006 (JP) 2006-206679

(51) Int. Cl. G09G 3/28

(52) U.S. Cl. 345/60

(57) ABSTRACT

A plasma display apparatus includes a display panel including first electrodes, second electrodes, and third electrodes, a first drive circuit configured to drive the first electrodes, a plurality of scan circuits configured to successively scan the first electrodes, a second drive circuit configured to drive the second electrodes, a third drive circuit configured to drive the third electrodes while the plurality of scan circuits successively scan the first electrodes to supply a drive power from the first drive circuit to the first electrodes, and a delay unit inserted into an interconnect connecting between at least one of the plurality of scan circuits and the first drive circuit, wherein electric currents supplied from the first drive circuit flow at different timings into at least two of the plurality of scan circuits in response to a propagation delay on the interconnect caused by the delay unit.

### BACKGROUND OF THE INVENTION

1. Field of the Invention

The present invention generally relates to plasma display apparatuses, and particularly relates to a scan driver and peripheral circuitry thereof in a plasma display apparatus.

2. Description of the Related Art

Flat display apparatuses using flat display panels have been put to practical use in wide areas of application from small displays to large displays, and are replacing the conventional cathode-ray tubes. A plasma display panel has two glass substrates which have electrodes formed thereon and define a space therebetween that is filled with discharge gas, and generates electric discharge by applying voltages between the electrodes so as to induce light emission from fluorescent substance provided on the substrates in response to the ultraviolet light generated by the electric discharge, thereby displaying an image. Plasma display panels are widely used as large-screen display apparatuses due to the facts that it is easy to make a large-sized screen, that its self-light-emission nature ensures high display quality, and that the response speed is high.

FIG. 1 is a cross-sectional view of a three-electrode-type flat-plane-discharge AC-PDP panel serving as an example of a large-size display apparatus.

The three-electrode-type flat-plane-discharge AC-PDP panel includes two glass substrates, i.e., a front glass substrate 15 and a rear glass substrate 11. On the front glass substrate 15, common sustain electrodes (X electrodes) and scan electrodes (Y electrodes), each of which is comprised of a sustain-purpose BUS electrode 17 and transparent electrode 16, are formed. The X electrodes and the Y electrodes alternate with each other. A dielectric layer 18 is formed on the X electrodes and Y electrodes, and a protective layer 19 made of MgO or the like is formed on top of the dielectric layer 18.

The BUS electrode 17 has high conductivity, and serves as reinforcement for the conductivity of the transparent electrode 16. The dielectric layer 18 is made of low-melting-point glass, and serves to maintain discharge based on wall charge.

Address electrodes 12 are formed on the rear glass substrate 11 in such a manner as to extend perpendicularly to the X electrodes and Y electrodes. A dielectric layer 13 is formed on the address electrodes 12. On the dielectric layer 13, partition walls 14 are formed at positions corresponding to the gaps between the address electrodes 12.

Between the partition walls 14, fluorescent layers R, G, and B are formed to cover the dielectric layer 13 and the side walls of the partition walls. The fluorescent layers R, G, and B correspond to red, green, and blue, respectively. When the PDP is driven, electric discharge between the X electrodes and the Y electrodes generates ultraviolet light, which excites the fluorescent layers R, G, and B to emit light, thereby providing display presentation.

The gap between the front panel having the X electrodes and Y electrodes and the rear panel having the address electrodes 12 is filled with discharge gas such as a mixture of neon and xenon. Space at the position where an X electrode and Y electrode intersect with an address electrode constitutes a single discharge cell (pixel).

FIG. 2 is a block diagram showing a main part of a related-art plasma display apparatus; A plasma display apparatus shown in FIG. 2 includes a plasma display panel 110, an address-electrode drive circuit 111, a scan driver circuit 112, a Y-electrode drive circuit 113, an X-electrode drive circuit 114, and a control circuit 115. The scan driver circuit 112 includes a plurality of scan driver ICs 120.

The control circuit 115 receives a clock signal, display data, a vertical synchronizing signal, a horizontal synchronizing signal from an external source, and generates control signals for controlling the panel operation based on the received signals and data. To be specific, the control circuit 115 receives the display data for storage in a frame memory, and generates an address control signal responsive to the display data stored in the frame memory in synchronization with the clock signal. The address control signals are supplied to the address-electrode drive circuit 111. The control circuit 115 further generates scan driver control signals for controlling the scan driver circuit 112 in synchronization with the vertical synchronizing signal and the horizontal synchronizing signal. The control circuit 115 further drives the Y-electrode drive circuit 113 and the X-electrode drive circuit 114 in synchronization with the vertical synchronizing signal and the horizontal synchronizing signal.

The address-electrode drive circuit 111 operates in response to the address control signals supplied from the control circuit 115, and applies address voltage pulses responsive to the display data to address electrodes A1 through Am. The scan driver circuit 112 operates in response to the scan driver control signal supplied from the control circuit 115, and drives scan electrodes (Y electrodes) Y1 through Yn independently of each other. While the scan driver circuit 112 successively drives the scan electrodes (Y electrodes) Y1 through Yn, the address-electrode drive circuit 111 applies the address voltage pulses to the address electrodes A1 through Am, thereby selecting cells to emit light so as to control light-emission/non-emission (selected-state/unselected-state) of each cell (pixel) 119 (only one pixel is illustrated for the sake of simplicity).

The Y-electrode drive circuit 113 applies sustain voltage pulses to the Y electrodes Y1 through Yn, and the X-electrode drive circuit 114 applies sustain voltage pulses to the X electrodes X1 through Xn. The application of these sustain voltage pulses generates sustain discharge between an X electrode and a Y electrode at the cells selected as display cells.

FIG. 3 is a diagram showing an example of a basic operation of the drive circuit shown in FIG. 2. The drive period of a PDP mainly consists of a reset period 31, an address period 32, and a sustain period 33. In the reset period 31, each display pixel is initialized. In the address period 32 that follows, pixels to be displayed (i.e., pixels to emit light) is selected. In the sustain period 33 that comes last, the selected pixels are caused to emit light.

In the reset period 31, predetermined voltage waveforms are applied to the Y electrodes Y1 through Yn serving as scan electrodes and to the X electrodes X1 through Xn, thereby initializing the state of all the display cells. Namely, the cells that emitted light on a preceding occasion and the cells that did not emit light on the preceding occasion are equally initialized to the same state.

In the address period 32, scan voltage pulses are successively applied to the Y electrodes Y1 through Yn serving as scan electrodes, thereby driving the Y electrodes Y1 through Yn one by one. In synchronization with the application of the scan voltage pulses to the Y electrodes, address voltage pulses responsive to the display data are applied to the address electrodes (A1 through Am). This serves to select display cells on each scan line. In FIG. 3, the diagonal line in the address period 32 illustratively indicates the scan timing of the Y electrodes Y1 through Yn.

FIG. 4 is an illustrative drawing showing an address voltage waveform applied to an address electrode and a scan voltage waveform applied to a Y electrode. FIG. 4-(b) illustrates a scan voltage waveform that is applied to a given Y electrode during the address period 32. As illustrated, a given Y electrode receives a negative voltage pulse at predetermined timing during the address period 32. In synchronization with the scan drive timing of each Y electrode, address voltage pulses responsive to data are applied to the address electrodes A1 through Am. FIG. 4-(a) illustrates an address voltage waveform that is applied to a given address electrode. In FIG. 4, a positive address voltage pulse is applied to an address electrode of interest at the timing at which a negative scan voltage pulse is applied to a Y electrode of interest, so that electric discharge occurs at the display cell positioned at the intersection of the Y electrode of interest and the address electrode of interest so as to generate wall charge, thereby selecting a light-emission state (ON-state). In the example shown in FIG. 4-(a), no positive address voltage pulse is applied to this address electrode of interest at any other timing during the address period 32. In this case, only one display cell corresponding to the Y electrode of interest is caused to emit light along the vertical line of the display panel corresponding to the address electrode of interest.

Turning back to FIG. 3, in the sustain period 33 following the address period 32, sustain pulses (sustain voltage pulses) at the common voltage level are alternately supplied to all the scan electrodes Y1 through Yn and the X common electrodes X1 through Xn. With this arrangement, the pixels selected in the address period to be in the light-emission state (ON-state) are cause to emit light. The continuous application of sustain pulses then achieves a display at predetermined luminance levels.

In the plasma display apparatus as described above, each display cell assumes only one of the two states, i.e., either the ON-state or the OFF-state, so that gray-scale tones cannot be represented by the magnitude of light-emission alone. In general, thus, the number of light emissions of each display cell is controlled to achieve the displaying of gray-scale tones. FIG. 5 is a drawing for explaining a method of displaying gray scales based on a sub-frame method that is widely employed today.

FIG. 5 illustrates a case in which 1024 gray scales are displayed by use of 10 sub-frames. One frame (one display image) is divided into 10 sub-frames SF1 through SF10. Each of the 10 sub-frames SF1 through SF10 is comprised of the reset period 31, the address period 32, and the sustain period 33 as described above. Drive operations for the reset period and the address period are substantially the same between different sub-frames, but the number of sustain pulses in the sustain period differs from sub-frame to sub-frame. Sub-frames having different numbers of sustain pulses are combined together to represent a desired gray scale.

There are many ways to assign the numbers of sustain pulses to the 10 sub-frames. In general, the numbers of sustain pulses in the 10 sub-frames are set to 2⁰=1, 2¹=2, 2²=4, . . . , and 2⁹=512, respectively. Sub-frames forming a desired combination of sub-frames selected from these 10 sub-frames are caused to emit light, thereby making it possible to represent 1024 gray scales at the maximum.

FIG. 6 is a drawing showing an example of the circuit configuration of a scan driver IC 120. The scan driver IC 120 of FIG. 6 includes a 64-bit shift register 51, a 64-bit latch 52, output drivers 53-1 through 53-64, and diodes D1 and D2 provided for each of the output drivers.

Power-supply terminals VH and GND of the scan driver IC 120 are connected to the Y-electrode drive circuit 113. An output control signal OC is also supplied from the Y-electrode drive circuit 113. In the Y-electrode drive circuit 113, the voltage applied to the power-supply terminal VH is maintained at a substantially constant voltage relative to the voltage of the power-supply terminal GND by absorbing voltage fluctuation through a condenser. Here, GND is the ground-potential side of the scan driver IC 120. As will be described in the following, however, GND is not fixed to a ground potential, but is caused to vary in accordance with its expected operation. The constant voltage between the power-supply terminals VH and GND is a high voltage higher than approximately 50 V.

The 64-bit shift register 51 receives input data DA indicative of the scan drive timings of the Y electrodes, and shifts the data DA successively in synchronization with a clock signal CLK. The 64-bit latch 52 latches a 64-bit output of the 64-bit shift register 51 in response to a latch-enable signal LE. The output drivers 53-1 through 53-64 transmit drive signals in response to the HIGH/LOW of the 64 respective outputs of the 64-bit latch 52. The data DA indicative of the scan drive timings of the Y electrodes is output as data DB to the exterior of the scan driver IC 120 after the propagation through the 64-bit shift register 51. The data DB is input as the input data DA into the 64-bit shift register 51 of a scan driver IC 120 provided at the next stage.

Respective outputs HVO1 through HVO64 of the 64 output drivers 53-1 through 53-64 are coupled to 64 Y electrodes. The output drivers 53-1 through 53-64 switch the states of the outputs HVO1 through HVO64 in response to the output control signal OC. When the output control signal OC is HIGH, for example, voltages responsive to HIGH/LOW of the 64 respective outputs of the 64-bit latch 52 may be output as the outputs HVO1 through HVO64. When the output control signal OC is LOW, on the other hand, the outputs HVO1 through HVO64 may be set to a high impedance (Hi-Z) state. Specifically, the outputs HVO1 through HVO64 of the output drivers 53-1 through 53-64 are set to Hi-Z during the sustain period, and are set to the voltages responsive to HIGH/LOW of the 64 respective outputs of the 64-bit latch 52 during the address period.

In the sustain period, the Y-electrode drive circuit 113 supplies positive and negative sustain voltages Vs alternately to the power-supply terminal GND, so that the sustain pulses are applied to the Y electrodes through the output drivers 53-1 through 53-64 and the diodes D1 and D2. When an electric current runs in the direction from the Y-electrode drive circuit 113 to a Y electrode, the current flows through the path that passes through the diode D2. When an electric current runs in the direction from a Y electrode to the Y-electrode drive circuit 113, the current flows through the path that passes through the diode D1 and one of the output drivers 53-1 through 53-64.

In the address period, further, a negative scan voltage is supplied from the Y-electrode drive circuit 113 to the power-supply terminal GND. The output control signal OC becomes HIGH at the start of the address period so as to activate the output drivers 53-1 through 53-64, so that each Y electrode is set to the voltage supplied through the power-supply terminal VH. Thereafter, the output drivers 53-1 through 53-64 successively drive the Y electrodes one by one in response to the data DA propagating through the 64-bit shift register 51 during the period in which the output control signal OC is maintained at the HIGH level. In so doing, the Y electrodes are driven by a scan voltage pulse responsive to the negative scan voltage supplied to the power-supply terminal GND. The output control signal OC is set to LOW at the end of the address period, which causes the output drivers 53-1 through 53-64 to come to a halt.

FIG. 7 is a drawing showing inputs and outputs of the scan driver IC 120 during the address period and the sustain period. FIG. 7-(a) illustrates the output waveforms of the output drivers 53-1 through 53-64 of the scan driver IC 120, FIG. 7-(b) illustrating the signal waveform of the output control signal OC, and FIG. 7-(c) illustrating the waveform of an electric current flowing into the power-supply terminal VH. The output waveforms (i.e., the voltage waveforms of the Y electrodes) shown in FIG. 7-(a) differ for each one of the 64 outputs during the address period, so that the successive scanning of the Y electrodes is illustrated by use of diagonal lines.

As shown in FIG. 7, an electric current flows into the power-supply terminal VH when the output control signal OC becomes HIGH during the address period. This is because the output drivers 53-1 through 53-64 are activated in response to the HIGH state of the output control signal OC so as to supply the voltage of the power-supply terminal VH to the Y electrodes having a predetermined capacitance connected to the outputs HVO1 through HVO64.

As shown in the entire configuration of the plasma display apparatus of FIG. 2, a plurality of scan drivers IC 120 are connected to the Y-electrode drive circuit 113. Since the output control signals OC applied to the plurality of the scan drivers IC 120 are all changed to HIGH simultaneously at the start of the address period, electric currents flows in the scan drivers IC 120 at the same time at the start of the address period. Consequently, a load is imposed on the power supply provided in the Y-electrode drive circuit 113, resulting in the generation of power-supply noise. This may give rise to the problem that the destruction of ICs and the malfunction of circuit control may become more likely to occur. There is another problem in that impact on the surrounding environment may become large due to the radiation of electromagnetic energy. It should be noted that these problems may arise not only at the start of an address period but also at the end of an address period.

Patent Document 1 discloses a technology for avoiding the concentration of current consumption in an LCD controller by supplying signals to respective source driver ICs while staggering their timings by use of dedicated signal lines for the individual source driver ICs.

[Patent Document 1] Japanese Patent Application Publication No. 2003-15613 Accordingly, there is a need for a plasma display apparatus in which the load on the power supply imposed by the electric currents flowing into a plurality of scan driver ICs is reduced.

### SUMMARY OF THE INVENTION

It is a general object of the present invention to provide a plasma display apparatus that substantially obviates one or more problems caused by the limitations and disadvantages of the related art.

Features and advantages of the present invention will be presented in the description which follows, and in part will become apparent from the description and the accompanying drawings, or may be learned by practice of the invention according to the teachings provided in the description. Objects as well as other features and advantages of the present invention will be realized and attained by a plasma display apparatus particularly pointed out in the specification in such full, clear, concise, and exact terms as to enable a person having ordinary skill in the art to practice the invention.

To achieve these and other advantages in accordance with the purpose of the invention, the invention provides a plasma display apparatus, which includes a display panel in which display cells are constituted at least by a set of electrodes including first electrodes extending in a first direction, second electrodes extending in the first direction, and third electrodes extending in a second direction substantially perpendicular to the first direction, a first drive circuit configured to drive the first electrodes, a plurality of scan circuits configured to successively scan the first electrodes, a second drive circuit configured to drive the second electrodes, a third drive circuit configured to drive the third electrodes while the plurality of scan circuits successively scan the first electrodes to supply a drive power from the first drive circuit to the first electrodes, and a delay unit inserted into an interconnect connecting between at least one of the plurality of scan circuits and the first drive circuit, wherein electric currents supplied from the first drive circuit flow at different timings into at least two of the plurality of scan circuits in response to a propagation delay on the interconnect caused by the delay unit.

According to at least one embodiment of the present invention, electric currents supplied from the Y-electrode drive circuit flow at different timings into at least two of the plurality of scan circuits. Accordingly, the electric currents do not flow simultaneously into these two scan circuits, thereby reducing the load on the power supply unit provided in the Y-electrode drive circuit. This can avoid the generation of power supply noise caused by an excessive load on the power supply unit, and eliminates the destruction of ICs and the malfunction of circuit control. Further, the emission of needless electromagnetic energy can be lowered.

### BRIEF DESCRIPTION OF THE DRAWINGS

Other objects and further features of the present invention will be apparent from the following detailed description when read in conjunction with the accompanying drawings, in which:

FIG. 1 is a cross-sectional view of a plasma display panel;

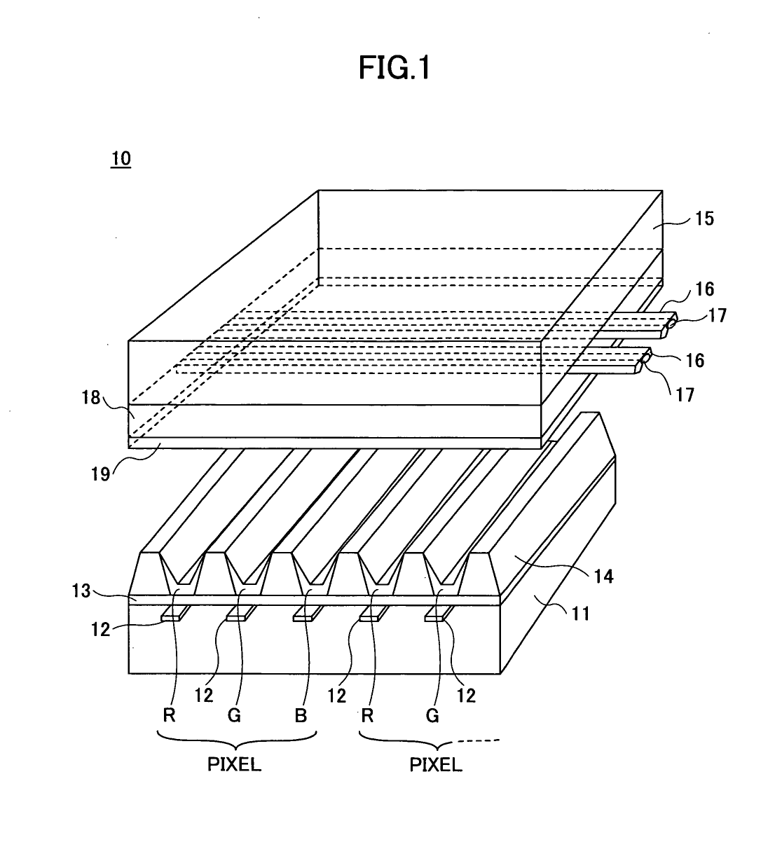

FIG. 2 is a block diagram showing a main part of a related-art plasma display apparatus;

FIG. 3 is a drawing showing an example of a basic operation of a drive circuit;

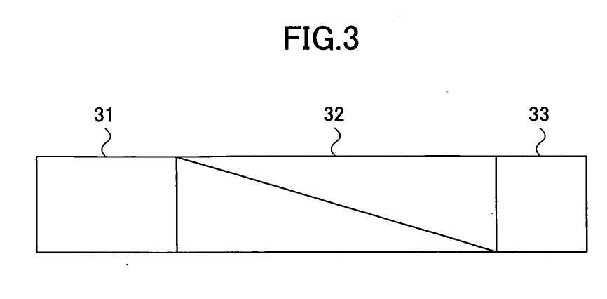

FIG. 4 is an illustrative drawing showing an address voltage waveform applied to an address electrode and a scan voltage waveform applied to a Y electrode;

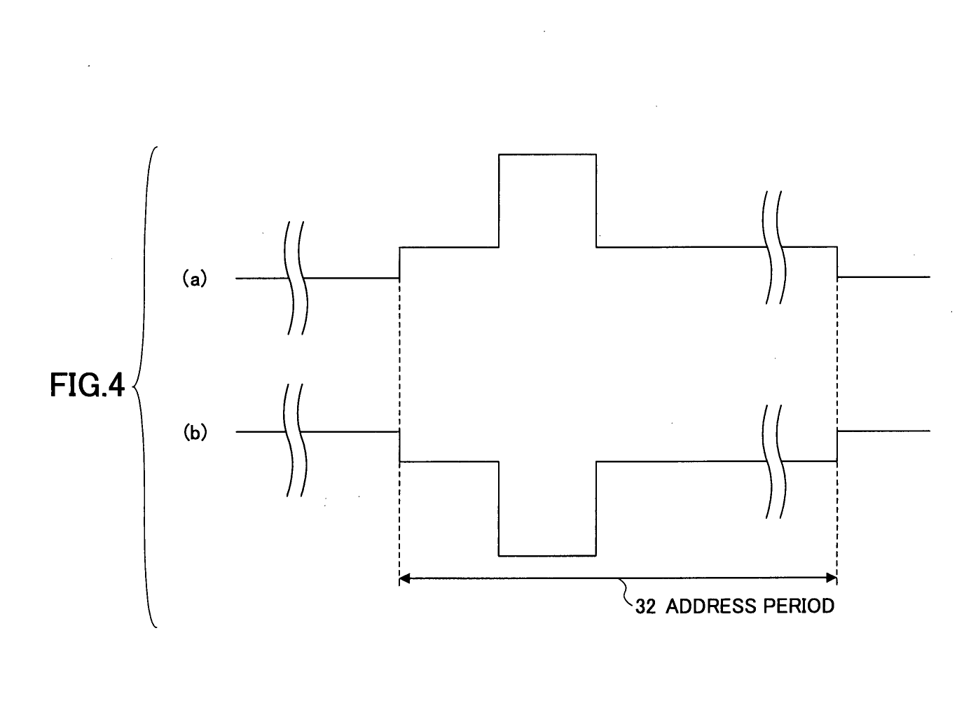

FIG. 5 is a drawing for explaining a method of displaying gray scales based on a sub-frame method;

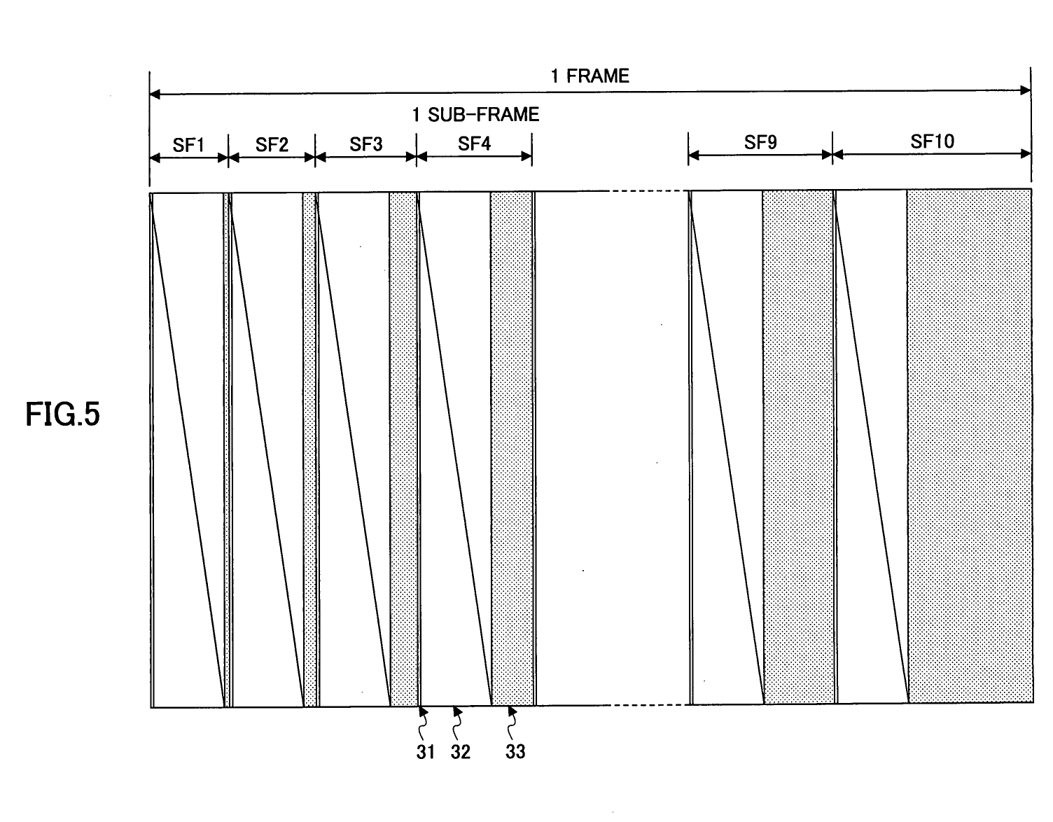

FIG. 6 is a drawing showing an example of the circuit configuration of a scan driver IC;

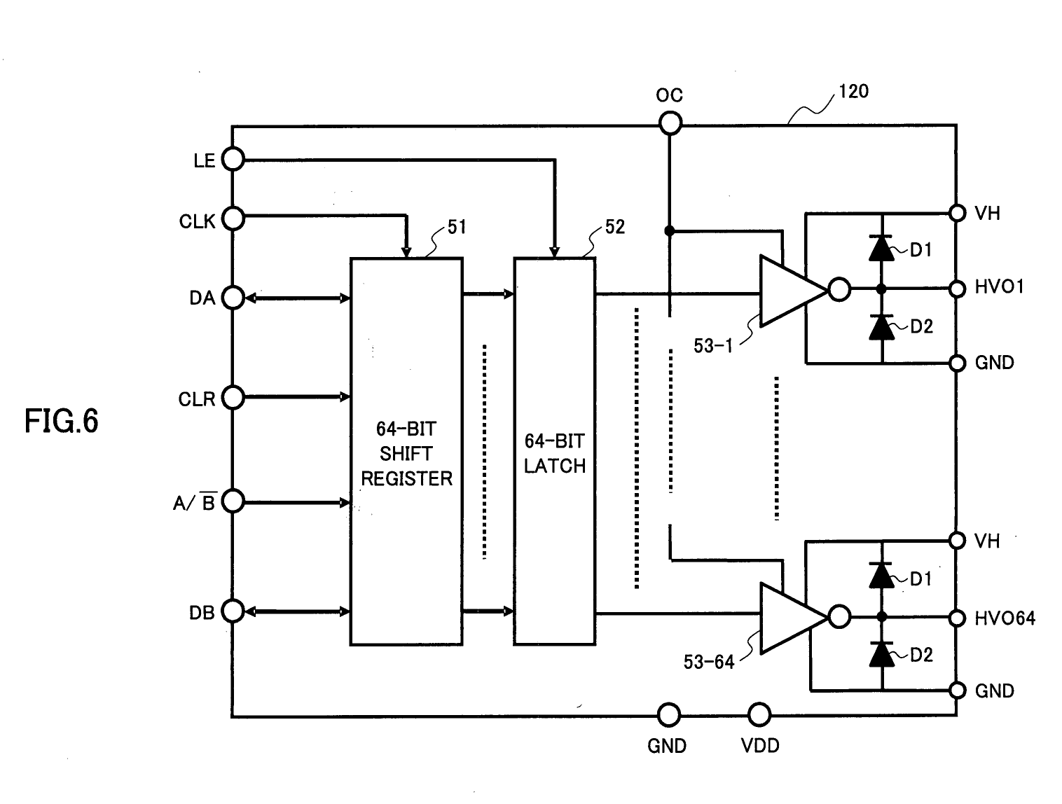

FIG. 7 is a drawing showing inputs and outputs of the scan driver IC during the address period and the sustain period;

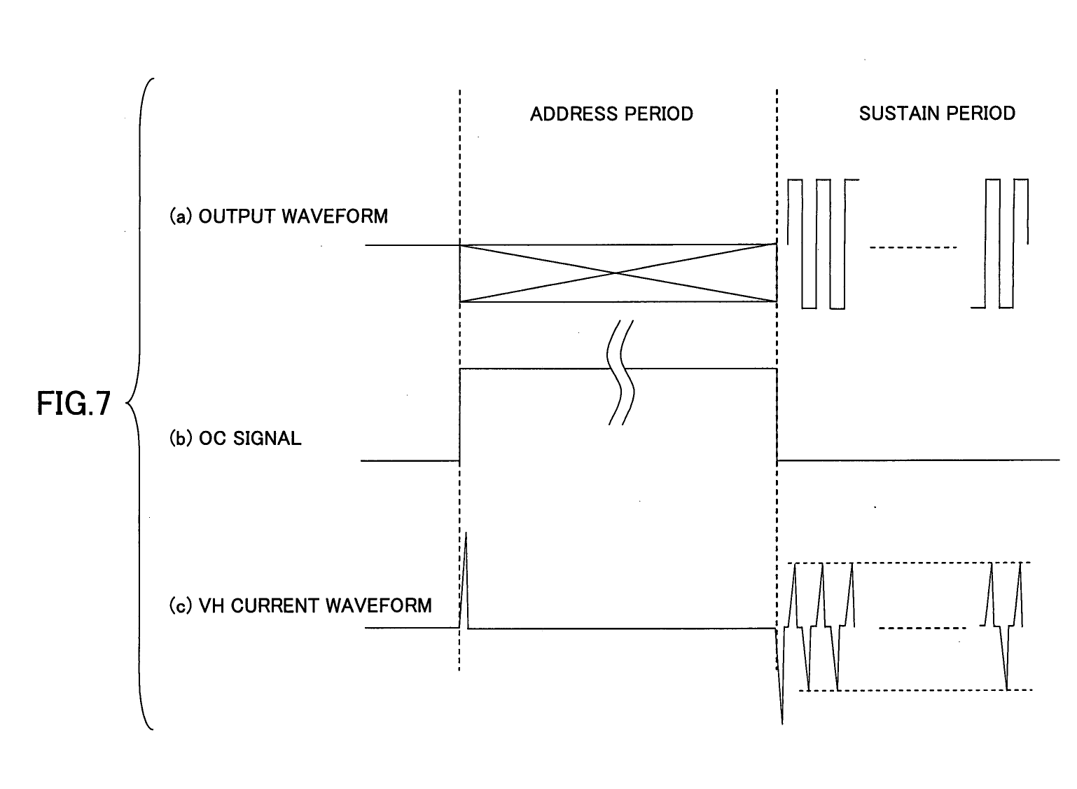

FIG. 8 is a block diagram showing a main part of a plasma display apparatus according to the present invention;

FIG. 9 is a drawing showing a first embodiment of a delaying mechanism achieved by the delay units;

FIG. 10 is a drawing showing an example of the configuration of the delay units implemented by use of a CR circuit;

FIG. 11 is a drawing showing an example of an output control signal delayed by the CR circuits having different capacitances;

FIG. 12 is a drawing showing a second embodiment of a delaying mechanism achieved by the delay units; and

FIG. 13 is a drawing showing a third embodiment of a delaying mechanism achieved by the delay units.

### DESCRIPTION OF THE PREFERRED EMBODIMENTS

In the following, embodiments of the present invention will be described with reference to the accompanying drawings.

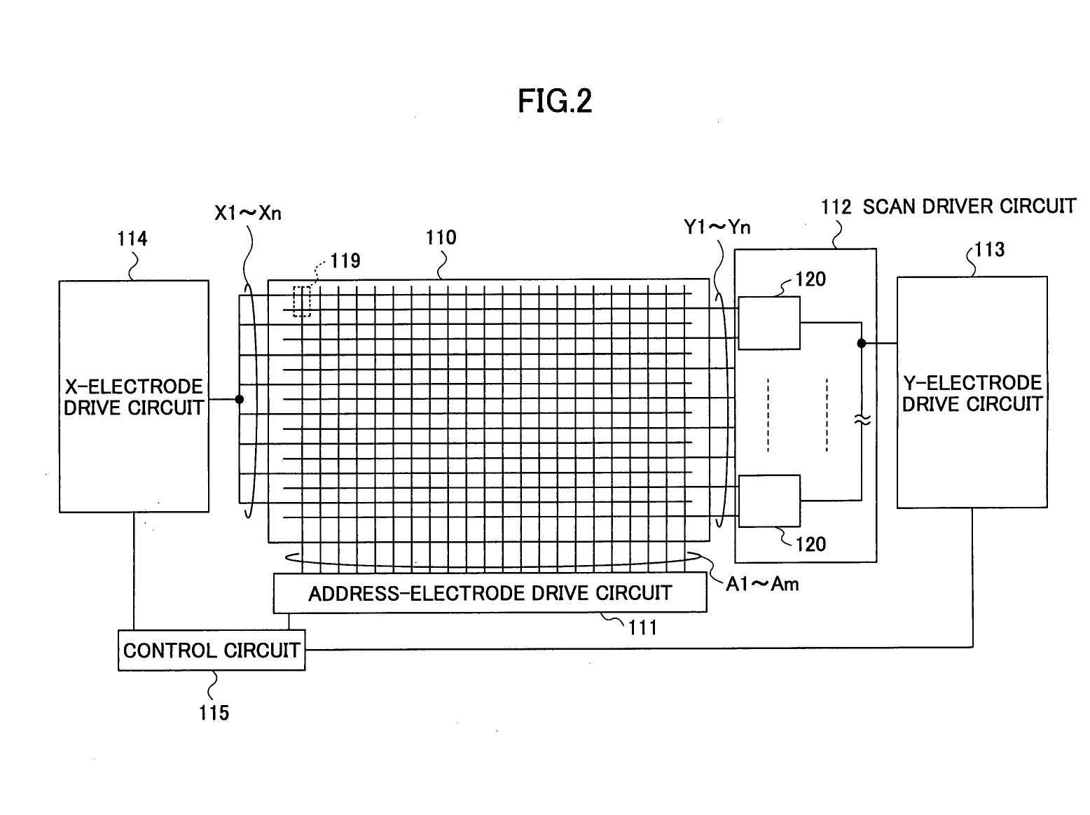

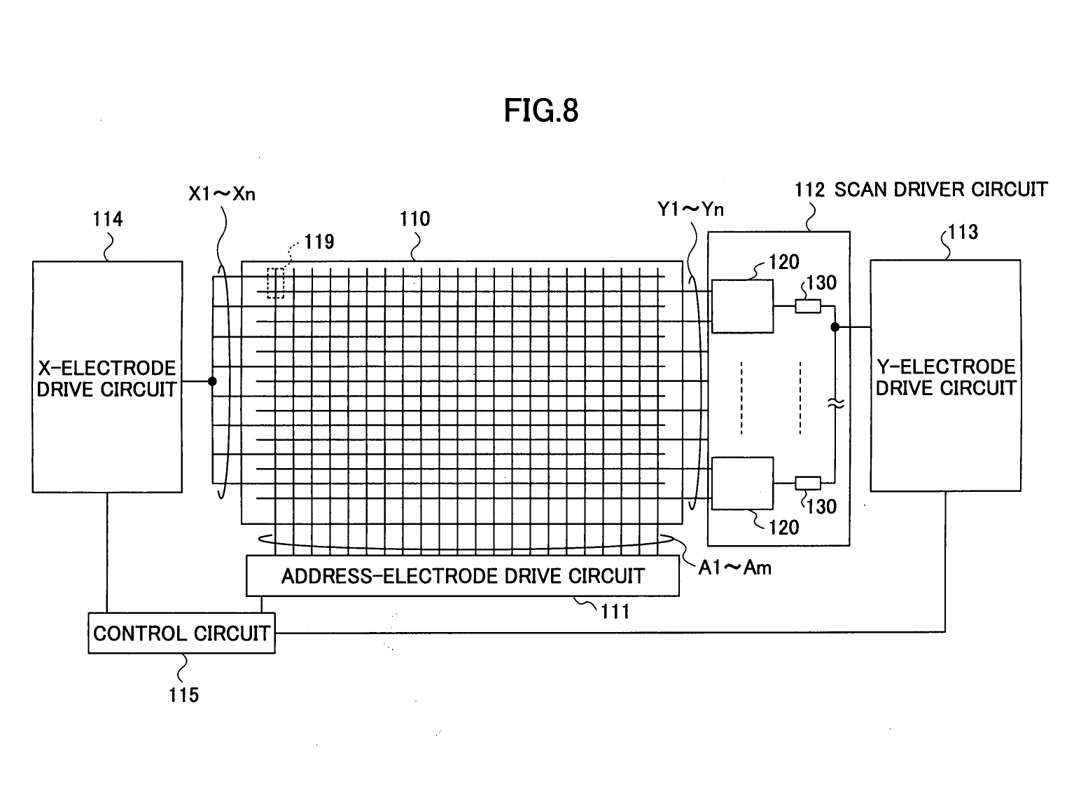

FIG. 8 is a block diagram showing a main part of a plasma display apparatus according to the present invention. In FIG. 8, the same elements as those of FIG. 2 are referred to by the same numerals, and a description thereof will be omitted.

A plasma display apparatus shown in FIG. 8 includes a plasma display panel 110, an address-electrode drive circuit 111, a scan driver circuit 112, a Y-electrode drive circuit 113, an X-electrode drive circuit 114, and a control circuit 115. The scan driver circuit 112 includes a plurality of scan driver ICs 120 and delay units 130. The delay units 130 are inserted into paths through which the output control signal OC or the power supply voltage VH is supplied from the Y-electrode drive circuit 113 to the scan driver ICs 120, and serve to delay the timing at which the output control signal OC supplied to the scan driver ICs 120 changes or the timing at which the electric current of the power-supply voltage VH supplied to the scan driver ICs 120 flows. At least two delay units 130 corresponding to at least two respective scan driver ICs 120 are configured to have respective delay lengths different from each other. Accordingly, the timing at which the output control signal OC changes or the timing at which the electric current of the power supply voltage VH flows differs between these two scan driver ICs 120. As a result, these two scan driver ICs 120 do not have electric currents flowing simultaneously, thereby reducing the load on the power supply of the Y-electrode drive circuit 113.

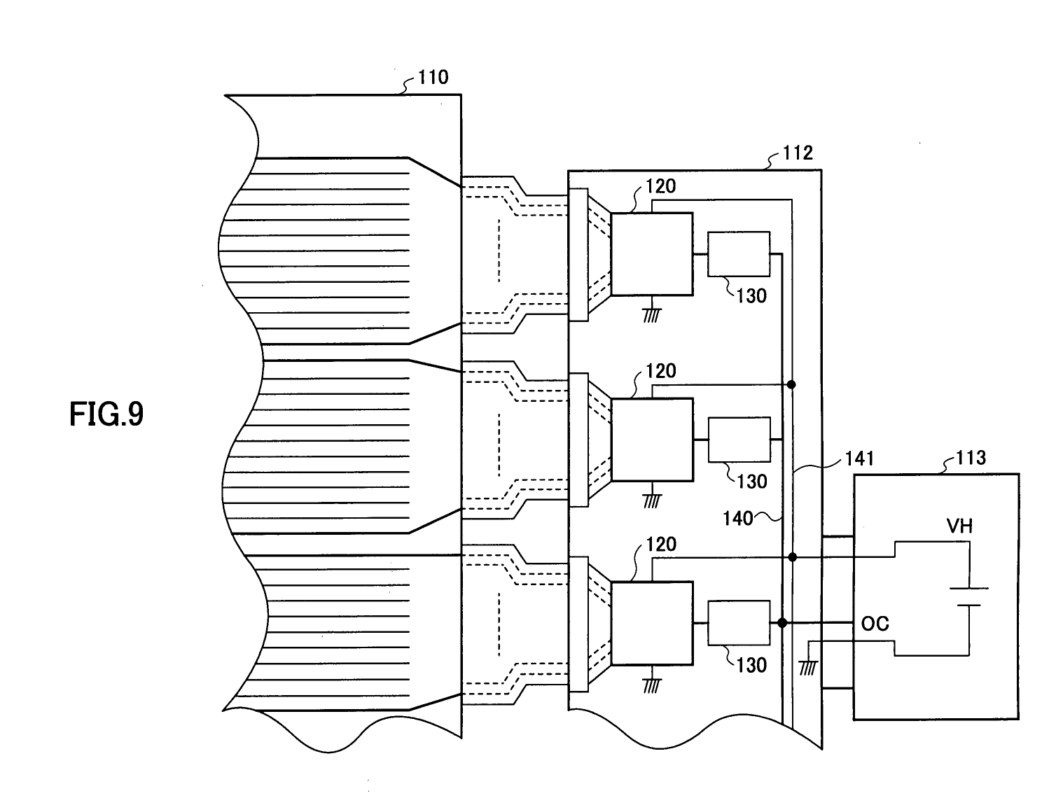

FIG. 9 is a drawing showing a first embodiment of a delaying mechanism achieved by the delay units 130. In the first embodiment shown in FIG. 9, the delay units 130 are configured to delay the timing at which the output control signal OC changes.

In FIG. 9, the output control signal OC is supplied from the Y-electrode drive circuit 113 to each of the scan driver ICs 120 via a signal line 140. Further, the power supply voltage VH is supplied from the Y-electrode drive circuit 113 to each of the scan driver ICs 120 via a power supply line 141. The delay units 130 are inserted into the signal line 140 in one-to-one correspondence to the scan driver ICs 120. The delay length of a delay unit 130 may be increased as the length of the signal line 140 from the Y-electrode drive circuit 113 to the scan driver IC 120 increases, for example. In this manner, the timings at which the output control signal OC supplied to the scan driver ICs 120 change are reliably dispersed.

Instead of increasing the delay length as the distance from the Y-electrode drive circuit 113 increases, the delay length may be increased as the distance from the Y-electrode drive circuit 113 decreases. Alternatively, delay lengths may be randomly assigned independently of the distance. In reality, the delay of the signal line 140 is present to some degree. Because of this, it may be preferable to use the configuration in which the longer the path of signal propagation on the signal line 140, the longer the selected delay length is, because such configuration can easily and reliably disperse the timings of the signal change. It should be noted that the delay units 130 do not have to be provided in one-to-one correspondence to all the scan driver ICs 120. Alternatively, the delay units 130 may be provided only for some but not all of the scan driver ICs 120.

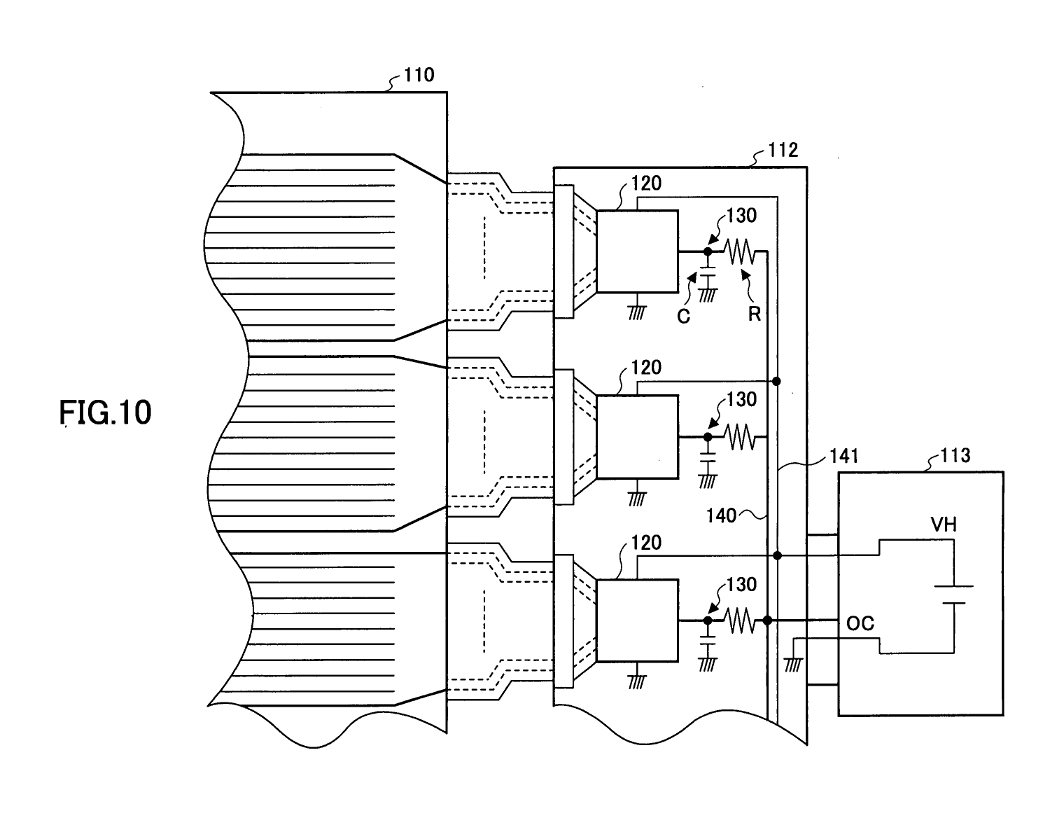

CR circuits or the like, for example, may be used as the delay units 130. FIG. 10 is a drawing showing an example of the configuration of the delay units 130 implemented by use of a CR circuit. As shown in FIG. 10, each of the delay units 130 includes a resistor R and a capacitor C. Due to the presence of the capacitor C, a change in the voltage of the output control signal OC delays on the signal line 140.

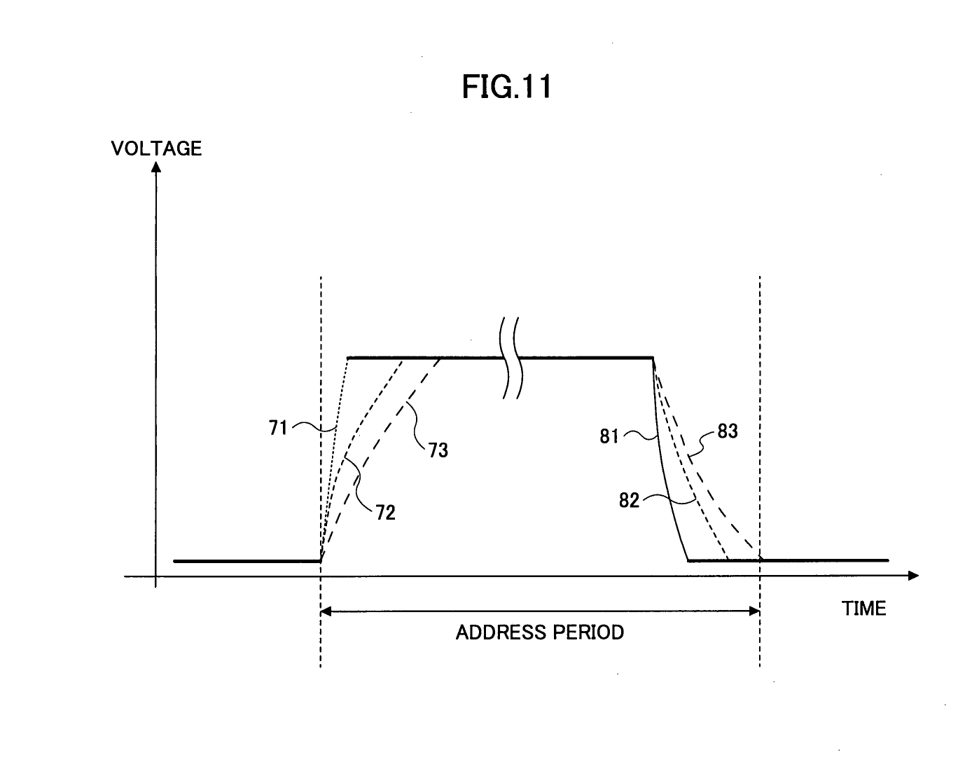

FIG. 11 is a drawing showing an example of the output control signal OC delayed by the CR circuits (delay units 130) having different capacitances for the capacitor C. When the capacitance of the capacitor C is smallest, the output control signal OC assumes a rise waveform 71 and a fall waveform 81. When the capacitance of the capacitor C is largest, the output control signal OC assumes a rise waveform 73 and a fall waveform 83. In the case of a capacitance having a mid value, the output control signal OC assumes a rise waveform 72 and a fall waveform 82. The larger the capacitance, the longer the signal delay is, as illustrated. The capacitance of the CR circuit of a delay unit 130 may be increased as the length of the signal line 140 from the Y-electrode drive circuit 113 to the scan driver IC 120 increases, for example. In this manner, the timings at which the output control signal OC supplied to the scan driver ICs 120 change are reliably dispersed.

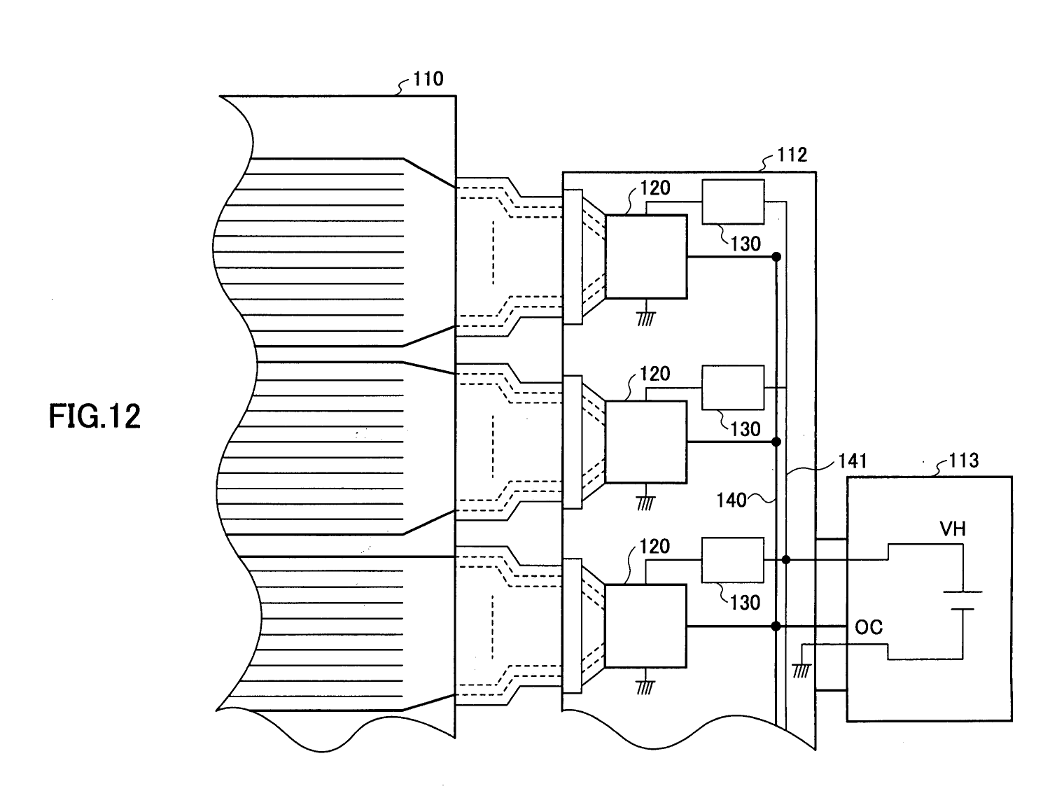

FIG. 12 is a drawing showing a second embodiment of a delaying mechanism achieved by the delay units 130. In the second embodiment shown in FIG. 12, the delay units 130 are configured to delay the timing at which the electric current of the power supply voltage VH flows.

In FIG. 12, the output control signal OC is supplied from the Y-electrode drive circuit 113 to each of the scan driver ICs 120 via a signal line 140. Further, the power supply voltage VH is supplied from the Y-electrode drive circuit 113 to each of the scan driver ICs 120 via a power supply line 141. The delay units 130 are inserted into the power supply line 141 in one-to-one correspondence to the scan driver ICs 120. The delay length of a delay unit 130 may be increased as the length of the power supply line 141 from the Y-electrode drive circuit 113 to the scan driver IC 120 increases, for example. In this manner, the timings at which the electric current of the power supply voltage VH supplied to the scan driver ICs 120 change are reliably dispersed. Similarly to the first embodiment, instead of increasing the delay length as the distance from the Y-electrode drive circuit 113 increases, the delay length may be increased as the distance from the Y-electrode drive circuit 113 decreases. Alternatively, delay lengths may be randomly assigned independently of the distance. Further, the delay units 130 do not have to be provided in one-to-one correspondence to all the scan driver ICs 120. Alternatively, the delay units 130 may be provided only for some but not all of the scan driver ICs 120. CR circuits or the like, for example, may be used as the delay units 130. In this case, the capacitive load is increased to increase the delay. Alternatively, an inductor may be used as a delay unit 130 to create a delay.

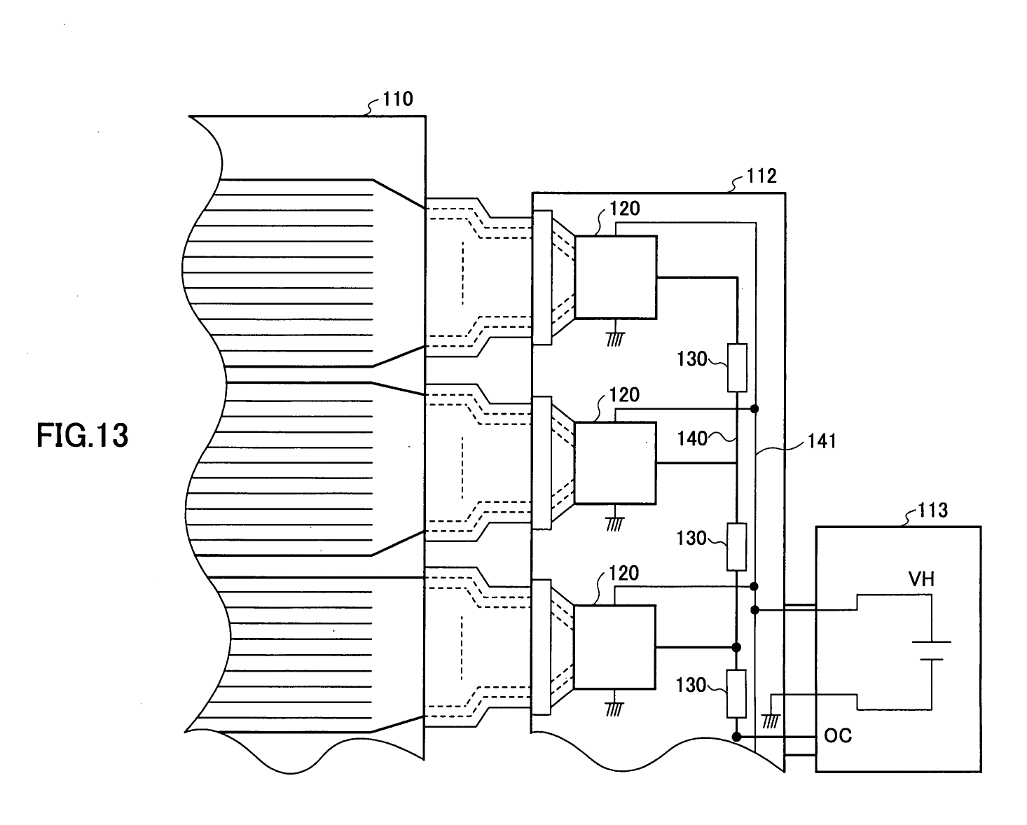

FIG. 13 is a drawing showing a third embodiment of a delaying mechanism achieved by the delay units 130. In the third embodiment shown in FIG. 13, the delay units 130 are configured to delay the timing at which the output control signal OC changes.

In FIG. 13, the output control signal OC is supplied from the Y-electrode drive circuit 113 to each of the scan driver ICs 120 via a signal line 140. Further, the power supply voltage VH is supplied from the Y-electrode drive circuit 113 to each of the scan driver ICs 120 via a power supply line 141. The delay units 130 are inserted into the signal line 140 in one-to-one correspondence to the scan driver ICs 120. The first embodiment and the third embodiment differ from each other in the positions at which the delay units 130 are inserted. In the case of the first embodiment, the signal line 140 branches into branch signal lines that are connected to the respective scan driver ICs 120, and each of the delay units 130 is inserted into a corresponding branch signal line extending between the branch point and the scan driver IC 120. In the case of the third embodiment, on the other hand, the signal line 140 branches into branch signal lines that are connected to the respective scan driver ICs 120, and each of the delay units 130 is inserted into a position between the branch point and the Y-electrode drive circuit 113 on the trunk signal line from which the branch signal lines extend. Namely, the delay units 130 are connected in parallel to each other in the first embodiment whereas the delay units 130 are connected in series in the third embodiment.

When the delay units 130 are connected in series as shown in FIG. 13, the delay units 130 may all be configured to have the same circuit configuration and the same circuit characteristics having the same delay. Even if all the delay units 130 have the same delay length, a signal with delay T after passing through a first delay unit 130 will have a delay equal to 2 T after gaining additional delay T by passing through a second delay unit 130. Accordingly, with the configuration in which the outputs of the delay units 130 connected in series are coupled to the respective scan driver ICs 120, signal timings for the scan driver ICs 120 can be made to differ. With this provision, the timings at which the output control signal OC supplied to the scan driver ICs 120 change can be reliably dispersed.

Further, the present invention is not limited to these embodiments, but various variations and modifications may be made without departing from the scope of the present invention.

The present application is based on Japanese priority application No. 2006-206679 filed on Jul. 28, 2006, with the Japanese Patent Office, the entire contents of which are hereby incorporated by reference.

What is claimed is:

1. A plasma display apparatus, comprising:
a display panel in which display cells are constituted at least by a set of electrodes including first electrodes extending in a first direction, second electrodes extending in the first direction, and third electrodes extending in a second direction substantially perpendicular to the first direction;
a first drive circuit configured to drive the first electrodes;
a plurality of scan circuits configured to successively scan the first electrodes;
a second drive circuit configured to drive the second electrodes;
a third drive circuit configured to drive the third electrodes while the plurality of scan circuits successively scan the first electrodes to supply a drive power from the first drive circuit to the first electrodes; and
a delay unit inserted into an interconnect connecting between at least one of the plurality of scan circuits and the first drive circuit,
wherein electric currents supplied from the first drive circuit flow at different timings into at least two of the plurality of scan circuits in response to a propagation delay on the interconnect caused by the delay unit.

2. The plasma display apparatus as claimed in claim 1, wherein the interconnect into which the delay unit is inserted is a signal line which supplies a signal defining a period of a scan operation performed by the plurality of scan circuits.

3. The plasma display apparatus as claimed in claim 1, wherein the interconnect into which the delay unit is inserted is a power supply line which supplies an electric power for driving the first electrodes through the plurality of scan circuits.

4. The plasma display apparatus as claimed in claim 1, wherein the delay unit is configured such that said at least two of the plurality of scan circuits are assigned with different propagation delays that increase as a distance from the first drive circuit increases.

5. The plasma display apparatus as claimed in claim 1, wherein the delay unit is configured such that said at least two of the plurality of scan circuits are assigned with different propagation delays independent of a distance from the first drive circuit.

6. The plasma display apparatus as claimed in claim 1, wherein the delay unit includes a capacitance device, and is configured to generate a propagation delay responsive to a capacitance of the capacitance device.

7. The plasma display apparatus as claimed in claim 1, wherein the delay unit includes a plurality of delay circuits, which are connected in parallel to each other on the interconnect.

8. The plasma display apparatus as claimed in claim 1, wherein the delay unit includes a plurality of delay circuits, which are connected in series to each other on the interconnect.
